(19) United States
(12) Patent Application Publication
(10) Pub. No.: US 2025/0245070 A1
(43) Pub. Date: Jul. 31, 2025

(54) COWBELL DISTRIBUTED WIRELESS COMPUTATIONAL PLATFORM

(71) Applicant: RAJANT CORPORATION, Malvern, PA (US)

(72) Inventors: Muthukumaran CHANDRASEKARAN, Malvern, PA (US); Volodomyr KONDRETENKO, Lviv (UA); Don GILBREATH, Malvern, PA (US); Jim CROYLE, Malvern, PA (US); Robert SCHENA, Malvern, PA (US); Banish OJHA, Malvern, PA (US); Spyridon MANGANAS, Malvern, PA (US); Muhammad ANJUM, Malvern, PA (US); Andrii SIRAK, Lviv (UA); Eugene SHCHEGLOV, Lviv (UA); Viktor NETOLYA, Lviv (UA); Olexandr TYSCHENKO, Lviv (UA); Abhay IYER, Malvern, PA (US)

(21) Appl. No.: 19/037,161

(22) Filed: Jan. 25, 2025

Related U.S. Application Data
(60) Provisional application No. 63/625,693, filed on Jan. 26, 2024.
(60) Provisional application No. 63/677,635, filed on Jul. 31, 2024.

(51) Int. Cl. G06F 9/50; G06F 9/54; H04L 41/12; H04L 67/12

(52) U.S. Cl. CPC G06F 9/5072; G06F 9/546; H04L 41/12; H04L 67/12; G06F 2209/505; G06F 2209/547

(57) ABSTRACT

A distributed computing platform that includes software solutions for managing distributed hardware devices that form a mesh communications infrastructure. Each hardware device provides an endpoint for user devices (e.g., sensors) and includes the processing power, expandable storage, and network communications capability required to perform cluster computing at the edge. The disclosed software solutions enable each hardware device to be automatically discoverable, seamlessly integrate additional hardware devices to the cluster, and enable end users to easily allocate the available computing resources. Accordingly, the disclosed distributed computing platform minimizes the need for onsite technical support while making complex preprocessing economically feasible for organizations that require distributed computing at the edge.

### CROSS-REFERENCE TO RELATED APPLICATIONS

This application claims the benefit of U.S. Prov. Pat. Appl. No. 63/625,693, filed Jan. 26, 2024, and U.S. Prov. Pat. Appl. No. 63/677,635, filed Jul. 31, 2024, both of which are hereby incorporated by reference as submitted in their entireties.

### FIELD OF THE INVENTION

The present disclosure relates to a distributed wireless computation platform and, more specifically, a distributed wireless computation platform for providing cluster computational resources over a mesh radio network.

### BACKGROUND

In many industries, the ability to quickly and accurately process information from remotely located personnel, assets, and sensors can mean the difference between success and failure. The adoption of machine learning (ML) algorithms that learn from data and make predictions or decisions without being explicitly programmed, for example, has surged across various industries. Deploying machine learning models presents unique challenges, however, especially in remote or challenging environments. Some implementations, for instance, may require that machine learning models be applied autonomously (or with minimal external dependencies), without constant communication with central servers (e.g., to perform low-latency decision support and/or in a location with limited network connectivity), and/or with specialized hardware accelerators (e.g., in resource-constrained environments that require the efficient utilization of computational resources).

Centralized cluster computing systems, where a group of computers (e.g., within a server room) work together to perform various computing tasks, can provide sufficient processing power (or can be scaled up to provide sufficient power) to perform any required function. Whether deployed on site or in the cloud, however, centralized cluster computing systems have a number of technical drawbacks. Existing cluster computing systems, for example, are challenging to configure and scale. For instance, existing cluster computing system typically require the integration of hardware, virtualization software, and software orchestration tools from separate vendors. Meanwhile, connecting cluster nodes requires the establishment and maintenance of networking hardware, the configuration and maintenance of a dynamic host configuration protocol (DHCP) server and a domain name system (DNS) server, etc.

Using a centralized cluster computing system to process data from disparate sources, in particular, requires the transmission of all of that data to the centralized system, which introduces latency (particularly in remote locations and other environments with limited network connectivity) and makes low-latency decision support systems impractical. Meanwhile, in many implementations, the sheer volume of data generated by connected devices can overwhelm even enterprise networks.

Edge computing systems, in which a distributed network of devices store and process data closer to the sources of that data, process data more quickly and eliminate the need to transfer all of the data to a centralized cluster computing system. By providing rapid and independent decision-making at the edge, edge computing systems reduce latency and improve response times, which is particularly important in scenarios where real-time information from personnel, assets, and sensors is critical (such as in command posts, robotic platforms, etc.).

The remote nodes of existing edge computing systems, however, can be even more difficult to configure and scale as centralized cluster computing systems. For example, current solutions (e.g., Azure IoT Edge®, AWS Snowcone® family) are limited to a specific location (a server room), require a cable networking connection, and lock clients to a cloud provider infrastructure. Those systems are also naturally scalable and, instead, require a specialist visit onsite for capacity increase. Another system, from Zededa®, implements only software components, without connectivity or hardware baseline. Accordingly, existing edge computing platforms (particularly when used to perform data-intensive machine learning processes) often require the setup of costly infrastructure for servers to operate (separate power, cooling, mounting options, dedicated space), costly onsite visits by a technical specialist for installation and maintenance operations, and replacement of equipment as computational demands increase.

Additionally, most existing platforms or solutions are isolated to specific functions and are typically not designed to simplify integration with disparate, non-native (or third-party) subsystems. End users, for example, may have specific hardware devices or software that requires specific operation systems or containerizations that are not supported by an existing platform. Those implementation difficulties (commonly known as “integration hell”) are particularly problematic when multiple teams or organizations that are not co-located need to exchange data and collaborate with little to no pre-coordination.

Accordingly, there is a need for a modular, extensible, operating system-agnostic edge computing system that provides fast deploy-ability, seamless on-demand “elastic” scaling, easy maintenance and management of the available computing resources, failure tolerance, and high availability for mission-critical applications. Additionally, in many implementations, there is a need for an edge computing system that utilizes ruggedized hardware and networking infrastructure (for prolonged and repeated indoor and outdoor use) while reducing reliance on internet connectivity and ensuring reliable and robust industrial connectivity even in challenging networking environments.

### SUMMARY

In order to address those and other drawbacks of the prior art, disclosed is a distributed computing platform that includes software solutions for managing distributed hardware devices that form a mesh communications infrastructure. Each hardware device provides an endpoint for user devices (e.g., sensors) and includes the processing power, expandable storage, and network communications capability required to perform cluster computing at the edge. The disclosed software solutions enable each hardware device to be automatically discoverable, seamlessly integrate additional hardware devices to the cluster, and enable end users to easily allocate the available computing resources. Accordingly, the disclosed platform may eliminate the need for a technical expert (or multiple technical experts) to be onsite.

By streaming and simplifying the on-site execution of end user applications (e.g., artificial intelligence and machine learning applications), the disclosed platform makes complex preprocessing economically feasible for organizations that require distributed computing at the edge.

### BRIEF DESCRIPTION OF THE DRAWINGS

For a detailed description of various examples, reference will now be made to the accompanying drawings in which:

FIG. 1 depicts a simplified system diagram for an electronic device of a platform and partially information on their interaction in accordance with one or more embodiments.

FIG. 2 depicts an exemplary schematic diagram of logical layers of the platform and interaction therebetween in accordance with one or more embodiments.

FIG. 3 depicts a simplified computing system in accordance with one or more embodiments.

FIG. 4 shows, in block diagram form, a simplified system diagram for an electronic device in accordance with one or more embodiments.

FIG. 5 shows an exemplary platform unit in accordance with one or more embodiments.

FIG. 6 shows an exemplary distributed edge computing system in accordance with one or more embodiments.

FIG. 7 shows an exemplary platform system architecture in accordance with one or more embodiments.

FIG. 8 shows an exemplary distributed edge cluster over mesh with a plurality of platform units in accordance with one or more embodiments.

FIG. 9 shows an exemplary platform unit software architecture in accordance with one or more embodiments.

FIG. 10 shows an exemplary platform unit's modular hardware architecture in accordance with one or more embodiments.

FIG. 11 shows exemplary hardware components in accordance with one or more embodiments.

FIG. 12 shows an exemplary automated inventory management system with robots in accordance with one or more embodiments.

FIG. 13 shows an exemplary Biomedical Monitoring System (BMS) applied to a swine model of toxic chemical exposure in accordance with one or more embodiments.

FIG. 14 shows an exemplary screenshot of an active session in progress on a remote monitoring platform for the BMS in accordance with one or more embodiments.

FIG. 15 shows an exemplary military environmental monitoring and occupational safety reporting system in accordance with one or more embodiments.

### DETAILED DESCRIPTION

The present embodiments may relate to, inter alia, systems and methods for providing cluster computational resources over a mesh radio network. In an exemplary embodiment, the disclosed technology provides a fully functional container orchestrator in a cluster formation. In some embodiments, cluster computational resources are provided over a mesh radio network, making cluster nodes independent from other nodes in terms of location.

The disclosed technology may provide technical improvements to a plurality of markets. Markets include, for example, energy, mining, warehousing, construction, manufacturing, logistics, ports, military, healthcare, or the like.

In some embodiments of the disclosed technology, a computing platform is provided that is a combination of hardware solutions and software code that deploys cluster management software. The platform allows remote deployment and on-site execution of Artificial Intelligence and Machine Learning (AI/ML) applications, without the need for a technical expert to be onsite. Such approach makes complex preprocessing economically feasible for businesses with a distributed nature of business. Additionally, or alternatively, each node may operate not only as a mesh node, but as a wireless hub (e.g., a Bluetooth® hub) or as a wireless access point (e.g., a WiFi® access point).

Key features of the disclosed computing platform include 1) simplified “bring your own apps” capabilities enabled by open APIs to integrate with the platform's core software; 2) scalability and extensibility over time enabled by a distributed edge cluster of edge over mesh; 3) high availability and failure tolerance enabled by a distributed edge cluster of edge over mesh; 4) peripherals integration (e.g., wearables, patient monitors, sensors (wired/wireless); 5) simplified AI application deployment and maintenance; 6) hardware-accelerated video analytics and low-latency decision support systems enabled by the platform's hardware; 7) seamless mesh network integration and configurability; 8) rugged industrial-grade enclosure with IP67 for indoor and outdoor use; 9) single vendor for hardware, software, applications, and networking; and 10) seamless Internet of Things (IoT) platform integration.

In some embodiments, the disclosed platform offers a single-vendor solution for the fragmented nature of commercially available platforms, providing a comprehensive integrated software, hardware, and networking infrastructure for cloud-native distributed computing at the edge utilizing what may be referred to as “MLOps-in-a-Box”. The platform streamlines and simplifies the delivery and management of AI applications at the edge.

Each unit of the platform may, for example, constitute a Rajant® BreadCrumb®, forming a Kinetic Mesh Network with other traditional Rajant® BreadCrumbs®. Each BreadCrumb® has the intelligence of Rajant's® proprietary InstaMesh® networking software, which dynamically selects the fastest data delivery paths, ensuring low-latency and high-capacity bandwidth for applications and no single point of failure. The platform's software enables automatic creation of a secure, fault-tolerant, highly available distributed computing cluster with data redundancy over the mesh network. Extending the cluster is as simple as adding more platform units to the deployment. The platform also offers an inline NSA-grade security module add-on for enhanced security.

In some embodiments of the disclosed technology, the disclosed platform may be equipped with applications for automated warehouse inventory management with multi-robot systems featuring AI-enabled pallet barcode detection and tracking and pallet localization. Additionally, or alternatively, the disclosed platform may feature applications for AI-enabled environmental exposure detection and tracking, which enables alerting for exposure to hazardous conditions with a combination of environmental monitoring, asset tracking (indoor RTLS (Real-Time Location System) and outdoor), and proximity detection, personnel safety monitoring, AI-enabled PPE detection, and personnel health and wellness monitoring. Further, the disclosed platform may feature applications for large animal monitoring and smart patient rooms.

One objective of the disclosed technology is to enhance operational agility and increase adoption through the simplification of the delivery and management of decision support systems. Another objective of the disclosed technology is the strategic use of distributed computing at the edge to increase decision-making speed, operational efficiency, and ultimately, mission success.

In some embodiments of the disclosed technology, the following technical effects are addressed:
1. Identifying and achieving appropriate SWaP (Size, Weight, and Power) to address constraints for mobile deployment.
2. A high degree of ruggedization to ensure these systems can withstand the harsh conditions often encountered in the field.
3. Clustering and load balancing capabilities to meet constantly changing resiliency, storage, and computation requirements.
4. Support for multi-tenant container runtime for virtualization and isolation of applications.
5. High-performance GPU and multi-core CPU to manage artificial intelligence workloads.
6. Software stack to facilitate flexible data transport suitable for a variety of use cases requiring low-latency cloud-native edge computing and AI-based computing solutions.
7. Software stack to streamline and simplify the delivery and management of applications that may also be AI-based at the edge.
8. Third party IP-based data transfer capability, including compatibility with highly resilient mesh networks, to ensure high speed, low latency, reliable, and secure communications between edge compute resources.
9. Independence from centralized, cloud, and network centric services to avoid dependencies on remote resources and the communication systems required to reach them.
10. Future-proof technology designed for scalability and adaptability to future needs, including potential upgrades or integration with emerging technologies.

### Exemplary Electronic Computing Device

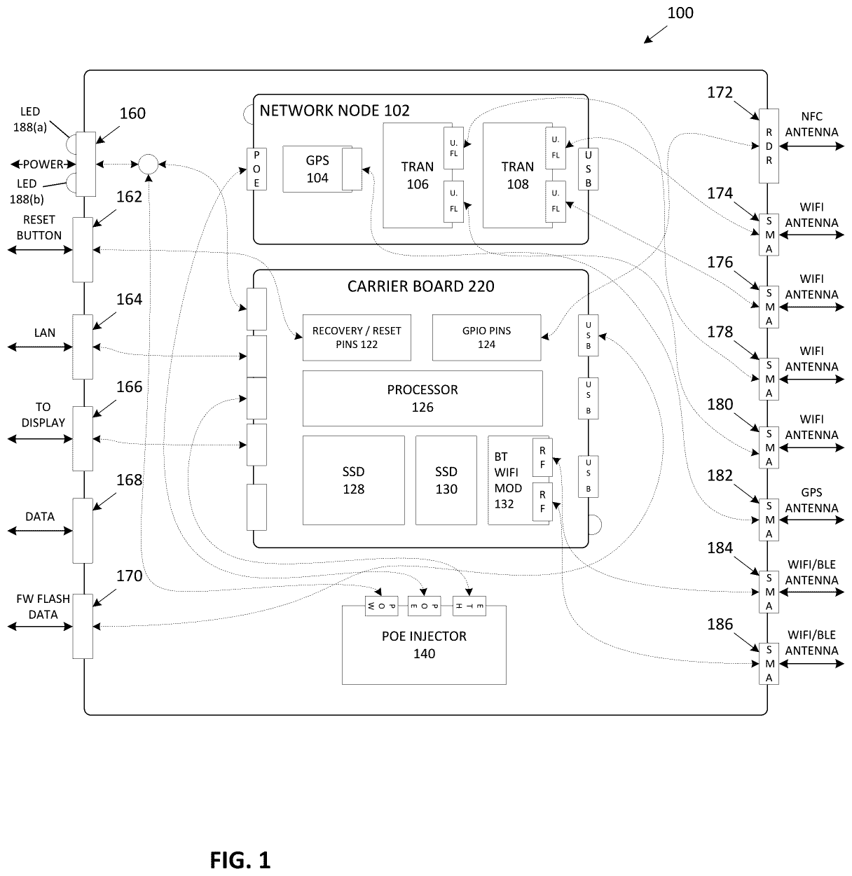

FIG. 1 illustrates a simplified functional block diagram of an illustrative programmable electronic computing device 100 as shown according to one embodiment. Electronic device 100 may be, for example, an edge computing device, a network computing node, a network mesh node, an AI-enabled computing device, or the like. As shown, electronic device 100 may include network node 102, carrier board 120, and POE injector 140. Device 100 may include multiple LEDs 188 (a) and 188 (b). The LEDs may provide indicators of varying colors to indicate carrier board status. Components of device 100 may be encapsulated by a custom, rigid case.

Network node 102 may include multiple components including GPS module 104, transceiver 106, and transceiver 108. GPS module 104 may be connected to a GPS antenna via SMA connector 182. Transceiver 106 may be connected to wireless antennas via SMA connectors 178 and 180. Transceiver 108 may be connected to wireless antennas via SMA connectors 174 and 176. Additionally, network node 102 may be connected to POE (Power over Ethernet) injector 140 via a POE connection. Network node 102 may include, for example, a BreadCrumb® (DX4) manufactured by Rajant®.

Carrier board 120 may include recovery/reset pins 122, GPIO pins 124, processor 126, SSD 128, SSD 130, and wireless module 132. Recovery/reset pins 122 may be connected to a reset button 162 of device 100. GPIO pins 124 may be connected to a near field communications (NFC) antenna via an RDR port 172 of device 100. Wireless module 132 may be connected to WIFI/BLE antennas via SMA ports 184 and 186. Carrier board 120 may be connected to multiple components of device 100 including, for example, power button 160, Local Area Connection (LAN) port 164, display device port 166, data port 168, and FW flash data port 170. Carrier board 120 may include, for example, a Jetson Orin NX/Nano® carrier board manufactured by NVIDIA®. Processor 126 may include, for example, a Jetson Orin NX/Nano® module manufactured by NVIDIA®.

POE injector 140 may be used to deliver power to other components of device 100. For example, POE injector 140 may deliver power over an Ethernet cable to network node 102 and processor 126 of carrier board 120. This example arrangement provides greater flexibility for deploying PoE-compatible equipment within device 100. As depicted, power may be provided to network node 102 and carrier board 120 from power connection 160 via POE injector 140.

### Exemplary Platform Logical Layers

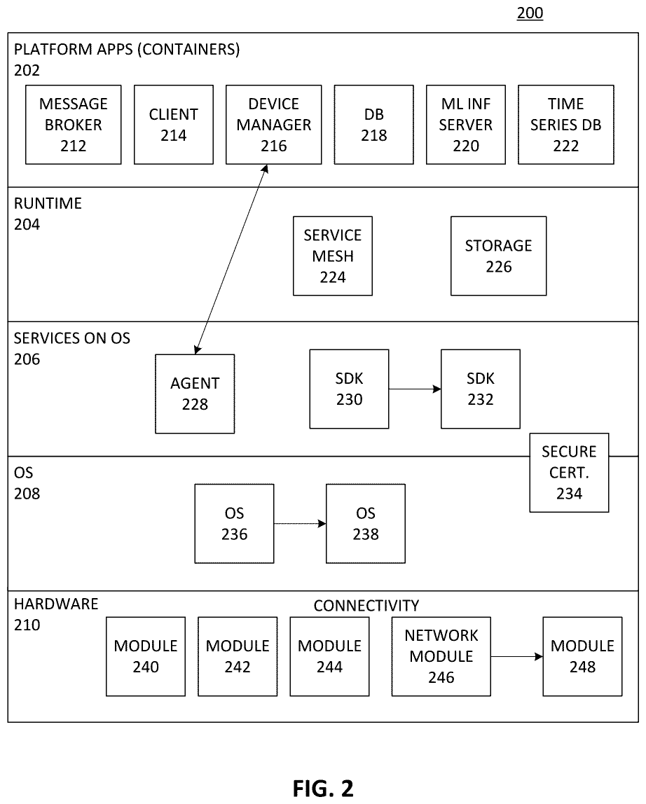

FIG. 2 depicts an example Platform as a Service (PaaS) 200 in accordance with at least one embodiment of the disclosed technology. PaaS 200 may be provided by a computing device, such as computing device 100 shown in FIG. 1. As shown, PaaS 200 may include a software stack that includes platform apps layer 202, runtime layer 204, services on OS layer 206, OS layer 208, and hardware layer 210.

Platform apps 202 may include multiple software containers including, but not limited to, message broker 212, client 214, device manager 216, database 218, machine learning inference server 220, and time series database 222. Device manager 216 may encapsulate logic that allows for the management of onsite deployment of devices in a single location. Architecture of the onsite deployment may resemble a monolith architecture with its own storage to keep the data. Device manager 216 may provide a graphical user interface through a web page for end users to interact with the system. Each platform device may include executable code that runs as a background service to establish connections with other platform devices. For example, a first platform device, operating as a platform node, may generate a secure certificate, such as secure certificate 234, that may be used for a handshake during connection establishment with a second platform device operating as another platform node. Additionally, or alternatively, each platform device may include executable code that runs as a background service to provide a constant flow of metrics and telemetry of the platform device to the local deployment of a device manager, such as device manager 216.

Runtime layer 204 may include, for example, service mesh 224 and storage 226.

Services on OS layer 206 may include, for example, agent 228, software development kits (SDK) 230 and 232, and secure certificate 234.

OS layer 208 may include, for example, OS 236, OS 238, and secure certificate 234.

Hardware layer 210 may include, for example, software modules 240, 242 and 244, network module 246, and connectivity module 248.

### Exemplary Platform Computing System

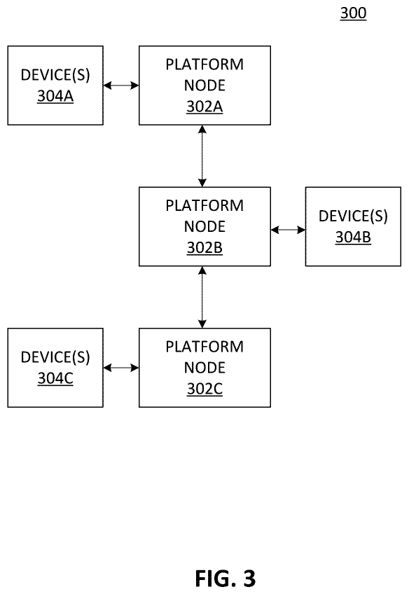

FIG. 3 depicts an example platform computing system 300. Platform computing system 300 may include one or more platform nodes, such as platform nodes 302A, 302B, and 302C. Platform computing system 300 may include more, or less, platform nodes shown in the illustrative example. Each platform node may include, for example, electronic computing device 100 (shown in FIG. 1). Platform nodes 302A, 302B, and 302C may be interconnected forming an interconnected network. Additionally, or alternatively, each of the platform nodes 302A, 302B, and 302C may be connected to one or more devices 304A, 304B, and 304C, respectively. Devices 304A, 304B, and 304C may include end-user devices, mobile devices, a desktop computer, a laptop computer, a personal digital assistant (PDA), a cellular phone, a smartphone, a tablet, wearable electronics, smart watch, or other web-based connectable equipment. Platform computing system 300 may include more, or less, devices 304A, 304B, and 304C shown in the illustrative example.

In the exemplary embodiment, devices 304A, 304B, and 304C may be computers that include a web browser or a software application, which enable devices 304A, 304B, and 304C to access remote computer devices, such as platform nodes 302A, 302B, and 302C, using the Internet or another network, such as a short-range wireless network. More specifically, devices 304A, 304B, and 304C may be communicatively coupled to platform nodes 302A, 302B, and 302C through many interfaces including, but not limited to, at least one of the Internet, a network, a local area network (LAN), a wide area network (WAN), a cellular phone connection, a cable modem, or the like. Devices 304A, 304B, and 304C may be any device capable of accessing the Internet including, but not limited to, a desktop computer, a laptop computer, a personal digital assistant (PDA), a cellular phone, a smartphone, a tablet, wearable electronics, smart watch, or other web-based connectable equipment or mobile devices.

### Exemplary Electronic Computing Device

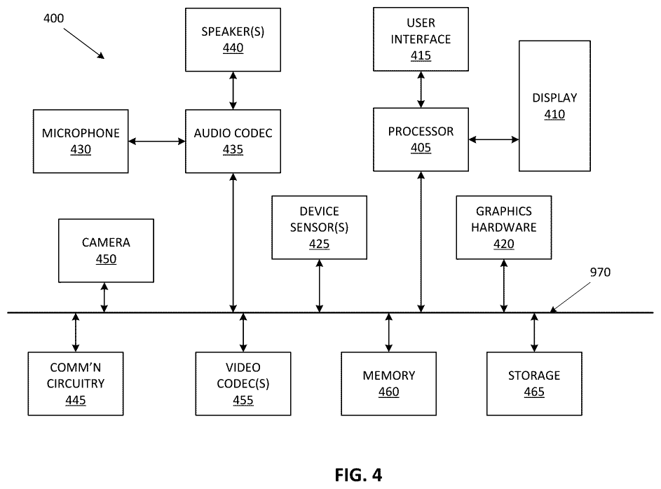

FIG. 4 illustrates a simplified functional block diagram of an illustrative programmable electronic computing device 400 as shown according to one embodiment. Electronic device 400 may be, for example, a mobile device (e.g., a cell phone), a personal media device, a portable camera, a tablet PC, a laptop, a desktop computer system, or the like. As shown, electronic device 400 may include a processor 405, a display 410, a user interface 415, graphics hardware 420, device sensor(s) 425 (e.g., proximity sensor/ambient light sensor, gyroscope, etc.), microphone input 430, an audio codec(s) 435, a speaker(s) 440, communications circuitry 445, a camera 450, video codec(s) 455, a memory 460, storage 465, and a communications bus 470.

Processor 405 may execute instructions necessary to carry out or control the operation of many functions performed by the electronic device 400. Processor 405 may, for example, drive display 410 and receive user input from user interface 415. User interface 415 can take a variety of forms, such as a button, a keypad, a dial, a click wheel, a keyboard, a display screen and/or a touch screen. User interface 415 could, for example, be the conduit through which a user may interface with the disclosed platform node, such as platform node 100 shown in FIG. 1. Processor 405 may be a system-on-chip (SOC) such as those found in mobile devices and include one or more dedicated graphics processing units (GPUs). Processor 405 may be based on a reduced instruction-set computer (RISC) or a complex instruction-set computer (CISC) architectures or any other suitable architecture and may include one or more processing cores. Graphics hardware 420 may be special purpose computational hardware for processing graphics and/or assisting processor 405 perform computational tasks. In one embodiment, graphics hardware 420 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as a neural engine processing core.

Memory device 460 may include one or more different types of media used by the processor 405 and/or graphics hardware 420 to perform device functions. For example, memory 460 may include memory cache, read-only memory (ROM), and/or random-access memory (RAM). Storage 465 may store media (e.g., audio, image and video files), computer program instructions or software, preference information, device profile information, and any other suitable data. Storage 465 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 460 and storage 465 may be used to retain computer program instructions or code organized into one or more modules and written in any desired computer programming language. When executed by, for example, the processor 405, such computer program code may implement one or more of the methods or processes described herein.

### Exemplary Platform Unit

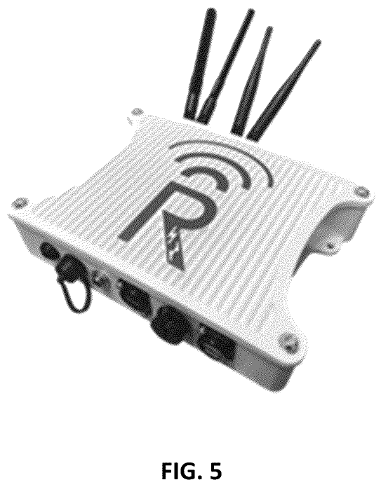

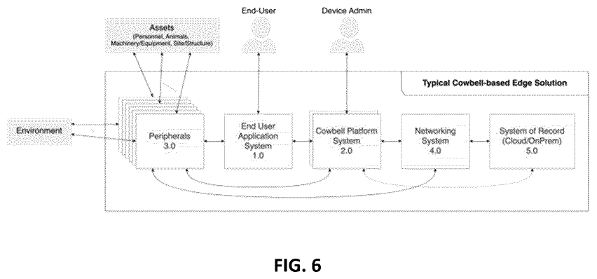

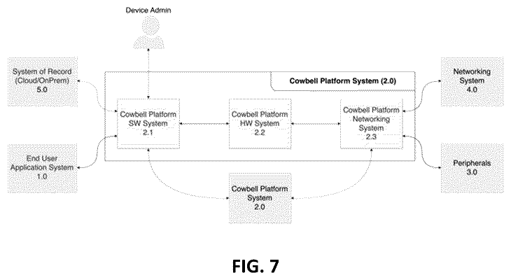

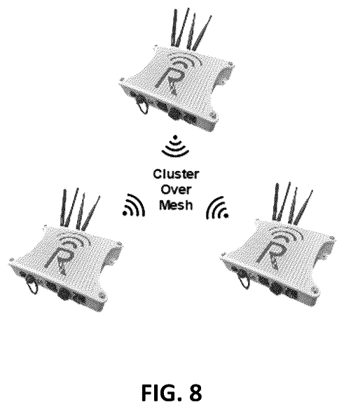

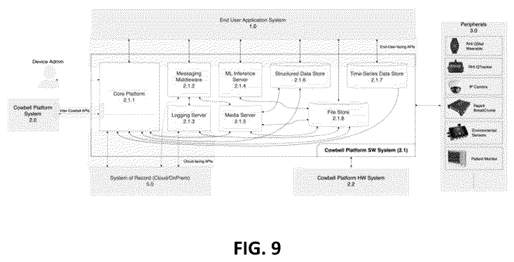

FIG. 5 depicts an example of a distributed edge computing platform unit (“platform unit”) in accordance with one or more embodiments of the disclosed technology. Illustrated in FIG. 6 is a typical distributed edge-computing solution based on the disclosed distributed edge computing platform. The platform unit enables a comprehensive edge computing solution that combines the software, hardware, and networking infrastructure needed to enable cloud-native distributed computing at the edge as shown in FIG. 7. By utilizing what is referred to as “MLOps-in-a-Box”, the platform streamlines and simplifies the delivery and management of AI and other compute-intensive applications at the edge. The platform unit provides a modular and extensible hardware architecture (shown in FIG. 8), and a flexible hardware-agnostic software architecture (shown in FIG. 9) in which most major subsystems are also operating-system-agnostic. All the platform's foundational software services are developed using “cloud native” technologies to avoid vendor lock-in with any cloud provider. Hence, the platform's services are deployable in a completely air-gapped environment and even in a hybrid edge and cloud environment. Each platform unit runs a software stack that enables dynamically configurable streaming and batch data pipelines suited for a variety of use cases in which low-latency AI-assisted intervention may be necessary.

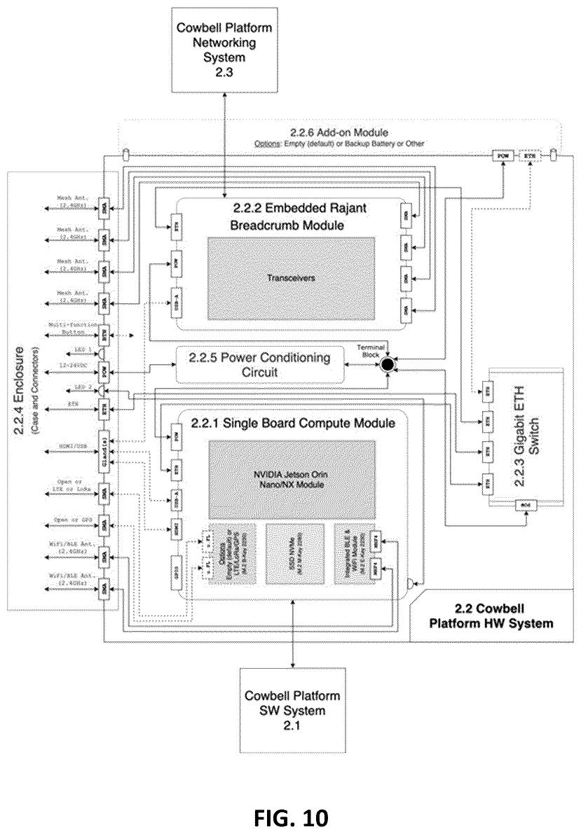

Referring to FIG. 10, the platform unit's software system (Component #2.1) provides a flexible and extensible software architecture for deploying and managing software applications, offering multi-tenancy and flexibility for application providers to bring their own applications into the platform by using the data APIs exposed by the platform unit's Core Platform (Component #2.1.1) services. It includes a container runtime for virtualization and isolation of the applications deployed in the system. Furthermore, it provides an integrated user interface for managing and configuring the cluster and other peripherals and orchestrating the applications. To augment that capability, the Core Platform enables the automatic discovery and creation of a secure, fault-tolerant, highly available (HA) distributed computing cluster (as shown in FIG. 8) with data redundancy, over the mesh network, or any network that it sits on. So, extending the cluster is as simple as turning more platform units on, making the platform fast- and easily deployable in the field by personnel who are not subject matter experts. Furthermore, the modular hardware design of the platform unit conceptualized in FIG. 10 allows the installation of new hardware accessories including a backup battery for wireless operation as an add-on module directly in the field.

The disclosed platform may host the End User Application System developed to effect real-time interventions by an end user. To do so, the platform may host a suite of services including a messaging middleware (Component #2.1.2), structured relational databases (Component #2.1.6), time-series databases (Component #2.1.7), a file store and management server (Component #2.1.8), and a logging server (Component #2.1.3). The platform also has the capability to optionally host a machine learning inference server (Component #2.1.4) which includes a hardware accelerator for optimizing machine learning inference workloads, and a Media Server (Component #2.1.5) utility to render live video streams in a web browser. The end-user applications may have full access to a dedicated partition of the database services or alternatively may decide to launch and maintain their own instances. The platform automates many deployment tasks, reducing reliance on IT and enabling its use by field deployed personnel.

Encased in a rugged industrial-grade IP-rated enclosure (Component #2.2.4), the platform unit may be a low-power device suitable for both indoor and outdoor use and features a single board computer module (Component #2.2.1) that includes a powerful CPU and GPU, along with wired (Serial, Ethernet) and wireless (Bluetooth, Wi-Fi) connectivity interfaces for seamless data processing and transfer. The platform unit may store large amounts of data (with a baseline capacity 1 TB SSD per hub, extensible up to 120 TB HDD) allowing the collection and persistence of data for an extended duration of time, and for various reporting and analytics to be executed for real-time intervention, utilizing both historical data and live streaming data.

The Platform's Networking System (Component #2.3) implements Rajant's InstaMesh®, Wi-Fi (802.11 WLAN), and the Bluetooth LE protocols for wireless connectivity, and USB/Serial and Ethernet drivers for wired connectivity. Each platform unit constitutes an Embedded Rajant BreadCrumb® Module (Component #2.2.2) making it also a mesh node in a Rajant Kinetic Mesh® Network. Since each platform unit may have the intelligence of Rajant's proprietary InstaMesh® networking software on board, it can dynamically select the best cost-effective path or paths for delivery from those meshed connections. Those communication modalities in the platform enable a flexible data transfer capability ranging from peer-to-peer (i.e., mesh) to point-to-point communications between edge compute resources. It may contain an industrial Gigabit Ethernet Switch (Component #2.2.3) to route communications at high-speeds between the compute and BreadCrumb® modules and from external ethernet-based data sources (e.g. IP Cameras). In some embodiments, platform units and other traditional Rajant BreadCrumbs® may form exceptionally large and very dense highly resilient distributed wireless mesh networks ensuring packet routing over multiple paths and frequencies to provide low-latency high capacity guarantees for bandwidth-intensive applications ensuring no single point of failure.

The platform unit's networking system is compatible and can integrate with almost all traditional communications infrastructure (including Cellular/LTE, Satellite, and Fiber). Furthermore, the radio nodes have integrated Wi-Fi access point service for compatibility with millions of commercial off-the-shelf (COTS) client devices (like laptops, tablets, smartphones, IP cameras, and Wi-Fi-based wearables) and a few custom devices (like the QStat Wearable described in U.S. Patent Application Publication 2022/0395225 A1). The disclosed platform may, in some embodiments, create a local network allowing it to function as a stand-alone edge computing hub even when it is completely isolated.

In some embodiments of the disclosed technology, the following key differentiators are described herein:
1. Identifying Simplified AI application deployment and maintenance with “MLOps-in-a-Box.”
2. Seamless Rajant Kinetic Mesh® network integration.
3. Simplified “bring your own apps” capability enabled by open APIs to integrate with Cowbell's core software platform.
4. Fast deployable as a standalone single- or multi-node cluster in completely air-gapped and/or hybrid edge-cloud environments, and on-premises.
5. Flexible hardware-agnostic software platform architecture in which most subsystems are also OS-agnostic.
6. No vendor lock-in or 3rd party software licenses with the use of cloud-native and open-source technologies.
7. Supports orchestration and management of both containerized and non-containerized applications.
8. Easily extensible with on-demand elastic scaling of the cluster over mesh (or any backbone network).
9. Secure, fault-tolerant, highly available distributed edge computing cluster with data redundancy.
10. Automatic discovery, creation, and management of a distributed edge computing cluster and resilient networking infrastructure enabled via a unified user-friendly UI for cluster, device, peripheral, application, and user management.
11. Managed services to allow ingestion, management, & analysis of data from multiple and disparate data sources.
12. Easily configurable HW-accelerated data (incl. video) analytics pipelines enabling low-latency decision support systems.
13. Powerful multi-core CPU and GPU with extensible HW expansion slots for storage (up to 120 TB), networking (including LoRa, LTE) and peripheral add-ons like a backup battery, GPS, and/or RiSM (Rajant Inline Security Module).
14. Full observability of the distributed edge computing cluster and networking infrastructure.
15. Wired and wireless (Bluetooth LE, Wi-Fi, and Kinetic Mesh®) peripherals integration and management.
16. Compatible with traditional communications infrastructure including Cellular/LTE, Satellite, Fiber, or the like.
17. Configurable as a Wi-Fi Access Point, DHCP server, and/or a Mesh networking node.
18. Rugged industrial-grade enclosure with IP67 for indoor and outdoor use.

### Use Cases

The following use cases demonstrate applications and implementations of the disclosed technology in real world environments. The examples provided are intended to give the reader a better understanding of the disclosed technology and are in no way meant to be limiting. In the use cases, the platform unit described herein may be referred to as a “Cowbell” device, such as the device depicted in FIG. 5.

### Use Case #1—Distributed Care Delivery Platform

One of the most significant challenges in addressing the diverse needs of underserved rural populations is scaling existing platforms to meet care standards across a variety of clinical use cases. That challenge arises because most existing platforms or solutions are isolated to specific functions and are typically not designed to simplify integration with disparate, non-native (or third-party) subsystems. Integration difficulties, commonly known as “integration hell,” are particularly problematic when multiple teams or organizations that are not co-located need to exchange data and collaborate with little to no pre-coordination. That often results in subsystems failing to seamlessly work together, leading to inefficiencies, data inconsistencies, and significantly hindering the pace of innovation.

Implementing a care delivery platform for diverse use cases faces operational challenges in delivering and managing disparate systems and services, especially those that are AI-based. Those systems are power and data intensive, and traditional cloud solutions are costly and introduce latency issues, making low-latency decision support systems impractical. That issue is exacerbated by unreliable communications, both due to operating in environments with limited network connectivity and the sheer volume of data generated by connected devices, which can overwhelm most enterprise networks. Furthermore, the importance of fast deploy-ability, ease of maintenance, data security, remote access, over-the-air software updates, seamless on-demand “elastic” scaling, failure tolerance, and high availability for mission-critical applications cannot be overstated. Additionally, reducing reliance on internet connectivity, optimizing and managing the use of the available compute (i.e. hardware) resources, utilizing ruggedized hardware and networking infrastructure for prolonged and repeated indoor and outdoor use, and ensuring reliable and robust industrial connectivity in challenging RF environments are critical considerations.

### Solution

We can systematically address the subset of challenges mentioned above by incorporating the distributed edge AI hub and platform-as-a-service, known as the Cowbell, as the cornerstone of the solution concept.

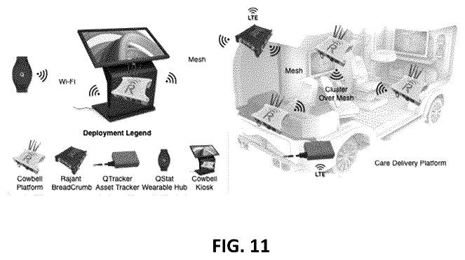

The Cowbell platform offers a single-vendor solution—first of its kind—for the fragmented nature of healthcare ecosystems, providing a comprehensive integrated software, hardware, and networking infrastructure for cloud-native distributed computing at the edge utilizing what we refer to as “MLOps-in-a-Box”. The platform streamlines and simplifies the delivery and management of AI applications at the edge. RHI's solution concept includes the components shown in FIG. 11. FIG. 11 depicts hardware components in the described solution concept including the Cowbell platform, Cowbell kiosks, Rajant BreadCrumb®, QTracker Asset Tracker, and QStat Wearable Hub.

Each Cowbell unit constitutes a Rajant BreadCrumb®, forming a Kinetic Mesh Network with other traditional Rajant BreadCrumbs®. Each BreadCrumb® has the intelligence of Rajant's proprietary InstaMesh® networking software, which dynamically selects the fastest data delivery paths, ensuring low-latency and high-capacity bandwidth for applications and no single point of failure. The Cowbell platform's software enables automatic creation of a secure, fault-tolerant, highly available distributed computing cluster with data redundancy over the mesh network, which is a groundbreaking innovation in the field. Extending the cluster is as simple as adding more Cowbell units to the deployment. The platform also offers an inline NSA-grade security module add-on for enhanced security.

Any BreadCrumb® node, including the Cowbell, is compatible with almost all traditional communications infrastructure (including Cellular/LTE, Satellite, and Fiber) and has an integrated Wi-Fi access point service for compatibility with various client devices including RHI's Q-Stat wearable device. Q-Stat is a low-power wearable and provides biometric, motion, and location data, along with raw waveforms with an open data API. Services to automatically format Q-Stat data into FHIR (Fast Healthcare Interoperability Resources) format for seamless integration with Electronic Medical Records (EMR) will be deployed and managed from the Cowbell Platform.

Cowbell provides the hardware and microservices-based software architecture for deploying and managing software applications, offering flexibility for application providers to bring their own applications for implementing any clinical services developed.

The Cowbells may also host the AI applications developed to enable a real-time AI-assisted intelligent task guidance system. To do so, the Cowbell platform, will host a suite of services including a machine learning inference server, a hardware accelerator (for optimizing machine learning workloads), a container runtime (for virtualization and isolation), a messaging middleware, and an integrated user interface for managing and configuring the cluster, applications, and other peripherals. The platform automates many deployment tasks, reducing reliance on IT and enabling use by medical professionals. Encased in a rugged industrial-grade enclosure, Cowbell is an extremely low-power device suitable for both indoor and outdoor use and features a powerful CPU and GPU, along with wired and wireless connectivity interfaces for seamless data processing and transfer.

Additionally, RHI could develop Cowbell Kiosks for in-home deployments and/or for highly frequented locations, enabling continuous and passive data collection from peripherals. The kiosks store data locally until a Care Delivery Platform (CDP) comes within range (if they do not have internet connectivity), automatically offloading data without human intervention. RHI also offers the QTracker, an LTE-based GPS asset tracker for integration into platforms like CDPs, featuring 3-wire hardware integration and services for fleet management integration, AI-based predictive maintenance, tamper detection, and analytics reporting.

Any BreadCrumb® node, including the Cowbell, is compatible with almost all traditional communications infrastructure (including Cellular/LTE, Satellite, and Fiber) and has an integrated Wi-Fi access point service for compatibility with various client devices including RHI's Q-Stat wearable device. Q-Stat is a low-power wearable and provides biometric, motion, and location data, along with raw waveforms with an open data API. Services to automatically format Q-Stat data into FHIR (Fast Healthcare Interoperability Resources) format for seamless integration with Electronic Medical Records (EMR) will be deployed and managed from the Cowbell Platform.

Cowbell provides the hardware and microservices-based software architecture for deploying and managing software applications, offering flexibility for application providers to bring their own applications for implementing any clinical services developed.

The Cowbells may also host the AI applications developed to enable a real-time AI-assisted intelligent task guidance system. To do so, the Cowbell platform will host a suite of services including a machine learning inference server, a hardware accelerator (for optimizing machine learning workloads), a container runtime (for virtualization and isolation), a messaging middleware, and an integrated user interface for managing and configuring the cluster, applications, and other peripherals. The platform automates many deployment tasks, reducing reliance on IT and enabling use by medical professionals. Encased in a rugged industrial-grade enclosure, Cowbell is an extremely low-power device suitable for both indoor and outdoor use and features a powerful CPU and GPU, along with wired and wireless connectivity interfaces for seamless data processing and transfer.

Use Case #2—Automated Inventory Management with Robots

### Problem

Manual inventory management in warehouses has been proven to be both inefficient and error-prone leading to long cycle times, labor-intensive processes, and consequently, increased reliance on operator training, exaggerated operational costs, and limited scalability. Moreover, the demanding working environments within warehouses, especially those subject to refrigeration, present considerable hazards to the safety and well-being of personnel and amplify the likelihood of human-caused errors. Furthermore, current inventory management processes inadequately capture essential operational efficiency-related tracking metrics, leading to delayed response times and impeding timely intervention strategies. Those issues highlight the pressing need for automated warehouse inventory management systems, which can streamline operations, reduce errors, enhance safety, and provide real-time tracking and early intervention capabilities, leading to improved efficiency and cost-effectiveness.

### Challenges

80% of the warehouses that exist today are not designed for automation. That poses significant challenges for automation that are as diverse as the products those warehouses store, making it cost prohibitive to justify traditional automation solutions, some of which typically require a major overhaul of systemic and operational processes. Providing a retrofitted automation solution while also making minimal systemic changes to address the logistical issues in inventory management is non-trivial. The complexity arises from a myriad of challenges rooted in their conventional design and variability. Additionally, in some cases, the unavailability of crucial information hampers full automation, requiring a digital transformation that can only be achieved through deliberate efforts with significant human intervention. Furthermore, integration with legacy and antiquated business systems is tedious and not scalable. Tailoring solutions to accommodate the variability among warehouses, encompassing environmental factors such as ambient working temperature, and lighting conditions, as well as layout and design considerations like the networking infrastructure, narrow aisles, and multi-level bays, and bay dimensions, alongside addressing issues like inconsistent or non-adherent operational procedures for barcode label placement, mitigating residual wrapping material, and pallet handling, renders fixed or programming-based automation solutions unsuitable. That underscores the need for flexible automation solutions capable of adapting to diverse warehouse environments and operational requirements.

### Why Traditional Automation Solutions Will Not Work?

A vision-based system incorporating a mobile robotic platform that utilizes artificial intelligence for barcode detection and feature-based navigation can provide the flexibility needed for automated inventory management in such disparate warehouse systems. However, they present several additional challenges associated with vision, power, connectivity, reliability, and scalability. For example, camera systems face issues such as occlusion, lens fogging, glare or shadows caused by poor lighting, as well as the difficulty in differentiating inventory barcodes from product barcodes. Mobile robotic platforms with limited payload capacity have severe size, weight, and power constraints causing further logistical problems with handling battery-operated systems and motion-induced noise and inaccuracies. That is exacerbated in refrigerated ambient operating conditions. Intermittent network connectivity and network bandwidth limitations typical in warehouses storing organic food products and metallic infrastructure necessitate a new breed of industrial wireless connectivity solutions and smart application management systems to dynamically optimize the allocation of data hungry services and get them to run close to where the data is being collected. Also needed, are the ability to scale the solution to increase capability (e.g. reduce cycle times) and resources available such as growing the robotic fleet without having to make significant infrastructural or hardware modifications.

### Unique Enablers

The Cowbell platform offers a unique approach to addressing the stove-piped nature of today's warehouse management ecosystems. It provides a comprehensive edge computing solution, offering the trifecta of software, hardware, and networking infrastructure to enable cloud-native distributed computing at the edge, utilizing what we refer to as “MLOps-in-a-Box”, to streamline and simplify the delivery and management of AI and other applications at the edge. To our knowledge, the Cowbell platform is the only single-vendor solution addressing all 3 facets of edge computing. Each Cowbell constitutes a Rajant BreadCrumb® making it also a mesh node in what Rajant calls a Kinetic Mesh® Network. Each BreadCrumb® has the intelligence of Rajant's proprietary InstaMesh® networking software on board, which dynamically selects the best cost-effective path or paths for delivery from these meshed connections. Cowbells and other traditional Rajant BreadCrumbs® can form exceptionally large and very dense highly resilient distributed wireless mesh networks ensuring packet routing over multiple paths and frequencies to provide low-latency high capacity guarantees for bandwidth-intensive applications ensuring no single point of failure. By leveraging Rajant's InstaMesh® technology, the Cowbell platform software enables the automatic discovery and creation of a secure, fault-tolerant, highly available (HA) distributed computing cluster with data redundancy, over the mesh network, which is a groundbreaking innovation in the field. So, extending the cluster is as simple as turning more Cowbell units on. Any BreadCrumb® node, including the Cowbell, is compatible with all traditional communications infrastructure (including Cellular/LTE, Satellite, and Fiber). Furthermore, the radio nodes have integrated Wi-Fi access point service for compatibility with millions of commercial off-the-shelf (COTS) client devices (like laptops, tablets, and smartphones).

### Solution

The disclosed Automated Inventory Management with Robots (AIMR) solution leverages Cowbells and other traditional Rajant BreadCrumbs® to provide a comprehensive automation solution constituting the edge computing hardware, a microservices-based reactive software architecture, and a low-latency, redundant and reliable network communications infrastructure needed to deploy and manage the software and AI applications and services needed for a flexible multi-robot automated inventory management system. It hosts a suite of applications including the middleware needed for creating and maintaining dynamic data pipelines, mission orchestration and fleet management, incident management, integration with business systems like Warehouse Management Systems, pallet barcode localization algorithms, computer vision-based image enhancement algorithms, and deep learning enabled hardware-accelerated pallet barcode identification. Cowbell automates many of the application deployment tasks, reducing the heavy reliance on IT, highly skilled DevOps engineers, and subject matter experts, during deployment and maintenance enabling its use by field operators (i.e., non-IT staff).

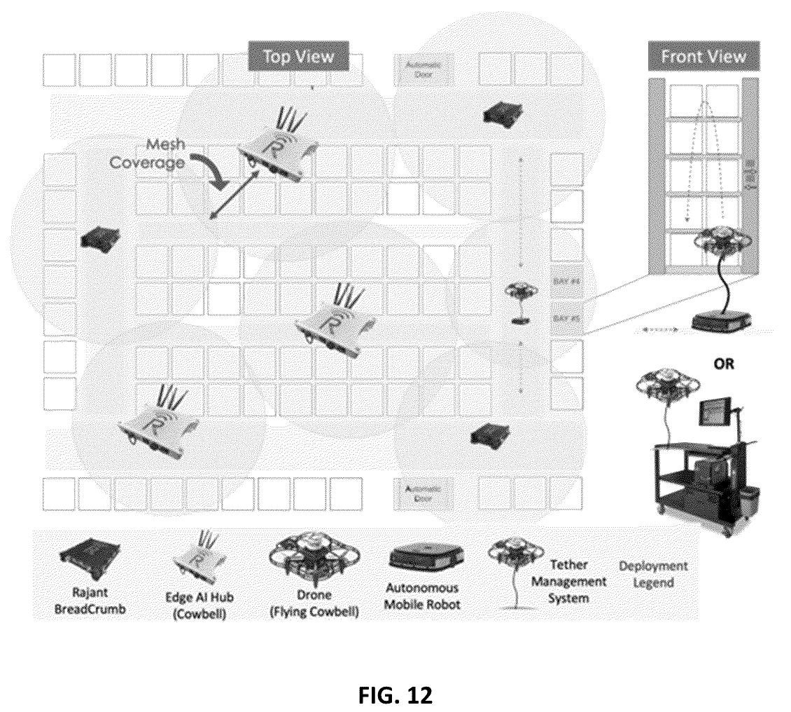

The AIMR solution illustrated in FIG. 12 includes a variant of the Cowbell that meets the size, weight, and power constraints of mobile robotic platforms (including drones) called the “Flying Cowbell” allowing the platform to host all the AI applications needed to process the camera feeds directly on-board to detect pallet barcodes and subsequently decode them using advanced image enhancement techniques, if necessary. Flying Cowbells cluster seamlessly with other traditional Cowbells. Central to this solution is a tether management system used to provide power to the mobile robotics platforms from high-capacity batteries hauled by either autonomous ground vehicles (also referred to as autonomous mobile robots) or pushcarts operated by safety personnel.

Powered by an industry-leading LIDAR-based simultaneous localization and mapping technology, the mobile platform can precisely determine its absolute position in the warehouse and compute the transformations needed to localize the observed pallet barcodes in the warehouse coordinate system and subsequently derive their corresponding pallet positions and matching them against the inventory-all in real-time. The system's findings are continuously updated in a user interface and database providing low-latency situational awareness to site supervisors and operations managers. The managers can then leverage the incident management service that uses the alerting and notification system deployed in the Cowbell to dispatch relevant personnel to fix issues discovered during the inspection. Additionally, to mitigate the risks associated with misclassifications due to poor observability, The disclosed AIMR solution incorporates an active continuous learning workflow for continued model refinement leveraging Cowbell's “MLOps-in-a-Box” capabilities. That workflow integrates techniques like semi-supervised learning and harnesses the insights of domain experts in a streamlined iterative process ensuring that AI models, deployed on Cowbell, can swiftly adapt to evolving environments and continually enhance their performance without imposing significant computational overhead. This targeted approach proves invaluable in situations where labeling vast amounts of video data is impractical due to time or resource constraints. Moreover, involving domain experts in the labeling process adds another layer of refinement. Their expertise aids in identifying patterns, rectifying misclassifications, and providing context-specific knowledge, thereby enriching the AI model's comprehension of the data. By constantly refining the model through active learning, not only are challenges such as data scarcity and domain shift addressed, but the model also remains relevant and effective in real-world deployment and post-production scenarios. This approach facilitates quicker iterations and fosters substantial return on investment.

### SUMMARY

The disclosed AIMR solution for real-time vision-based automated inventory management represents a sophisticated convergence of complex state-of-the-art technologies by harmoniously integrating advanced robotics, deep learning, enhanced video analytics, and computer vision and simplifying their delivery and management at the edge, enabled by the disclosed new edge-computing product line called the Cowbell and the disclosed proprietary fully mobile, rapidly scalable, high-capacity, industrial wireless connectivity. That system transforms traditional warehousing operations by retrofitting existing infrastructures notorious for challenging environmental working conditions and harsh RF environments not originally designed for automation, thereby ushering in a new era of modern and reliable inventory management solutions.

### Use Case #3—Biomedical Monitoring System: Swine Model of Toxic Exposure Use Case

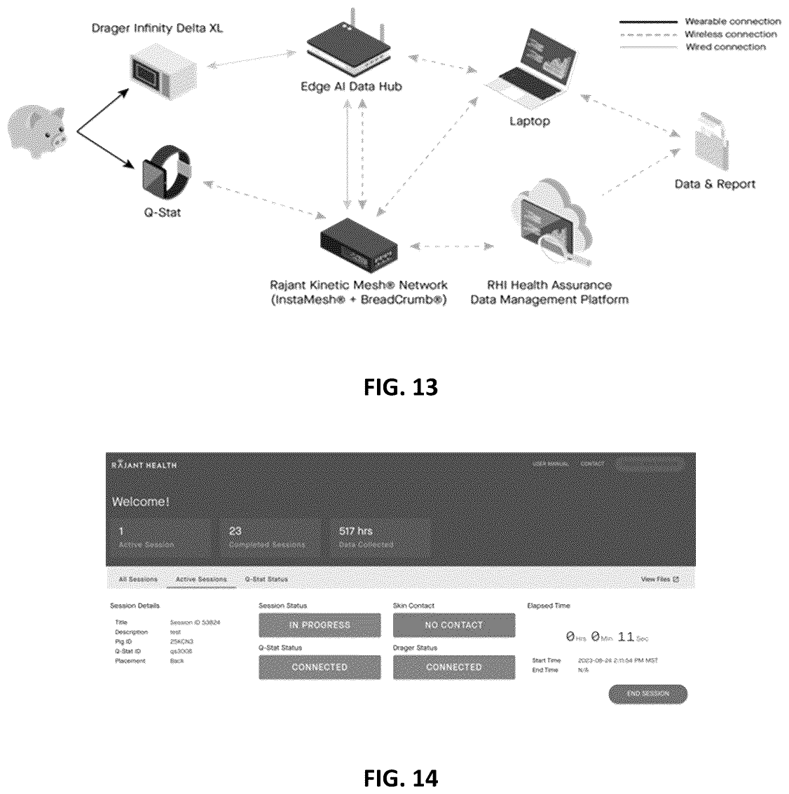

Our prototype Biomedical Monitoring System (BMS) is currently implemented in the surgery suite for an academic translational research center focused on developing life-saving interventions for toxic exposures in swine models. The center's physiological monitoring was previously limited to when animals were invasively wired to the Drager Infinity Delta XL patient monitor with both laboratory and vivarium staff present. Due to those requirements, data collection was arduous and restricted to short periods of time. FIG. 13 depicts an overview of the BMS applied to a swine model of toxic chemical exposure.

Swine wore a Q-Stat that enabled remote physiological monitoring and were connected to the facility's Drager Infinity Delta XL patient monitor. The disclosed Edge AI Data Hub (i.e. Cowbell) collected all data streaming from both devices, simultaneously. The Cowbell processed the data to compile analytics reports and visualizations locally. RHI Health Assurance Data Management Platform (HADMAP) ingested all data and reports for additional analysis, long-term data storage, and algorithm development. The Rajant Kinetic Mesh® Network provided a secure and isolated LTE network for all data transfer. Users had access to a web-based application to create, view, and manage monitoring sessions and associated data.

Our BMS enabled the facility to remotely and non-invasively monitor swine during toxic exposure procedures. The backbone of the system was the Rajant Kinetic Mesh® Network, which provided fail-proof broadband connectivity for data transfer. It is a self-managing and self-optimizing mesh network facilitated through BreadCrumb® hardware and InstaMesh® software. That connectivity in the BMS significantly increased data integration from Drager patient monitor to 1 datapoint per second on all desired physiological parameters. The system also integrated data from RHI's proprietary Q-Stat physiological wearable data hub at an even higher rate, 25 datapoints per second.

The Q-Stat leverages state-of-the-art low-power wearable technology with medical-grade components. It has a photoplethysmography (PPG) component, a Wi-Fi module, a Bluetooth LE (BLE) module, flash memory, SRAM, Li-ion battery, a surface temperature thermometer, and an inertial measurement unit (IMU). Prototype algorithms process data for pulse rate (PR) and blood oxygen saturation (SpO2). Projects are currently ongoing to automatically format Q-Stat data into FHIR (Fast Healthcare Interoperability Resources) format for inclusion in Electronic Health Records (EHR), such as MHS GENESIS or ILER. The increased data resolution and integration into clinical records will allow the facility and clinicians to gain further insight into the consequences and treatment of toxic exposures.

The data was streamed to our Cowbell platform, which has a high-performance GPU and a multi-core CPU running a software stack that enables a plethora of streaming and batch data pipelines suited for a variety of use cases where low-latency AI-assisted intervention may be necessary. The Cowbell platform was a gateway for securely ingesting incoming data from multiple data sources at the edge (e.g., Q-Stat, Drager monitor) through wireless (BLE or Wi-Fi) and wired (Ethernet or serial). The Cowbell platform contains a BreadCrumb® for seamless integration into the mesh network, all within an IP-rated enclosure for ruggedness. It supports HTTP and MQTT protocols, auto connects to pre-discovered Wi-Fi and mesh networks, and runs select services on a Linux-based system.

All software services within the system were written in cloud agnostic formats, allowing for use on our Cowbell. Our services managed the incoming data through a user interface (UI). The UI provided access to active data sessions in “All Sessions” and “Active Sessions” tabs, showed connected devices in the “Q-Stat Status” tab, and indicated any disruptions during a session using alerts. After a session was completed our report generation services transformed the disparate data streams into constructive graphs for interpretation by research professionals. Of particular use, overlays of the wearables and Drager PR data, and of low-quality data and motion provided the facility with valuable comparisons. A user interface of an example active session in progress on the remote monitoring platform is depicted by FIG. 14.

### Use Case #4—Military Environmental Monitoring and Occupational Safety Reporting System

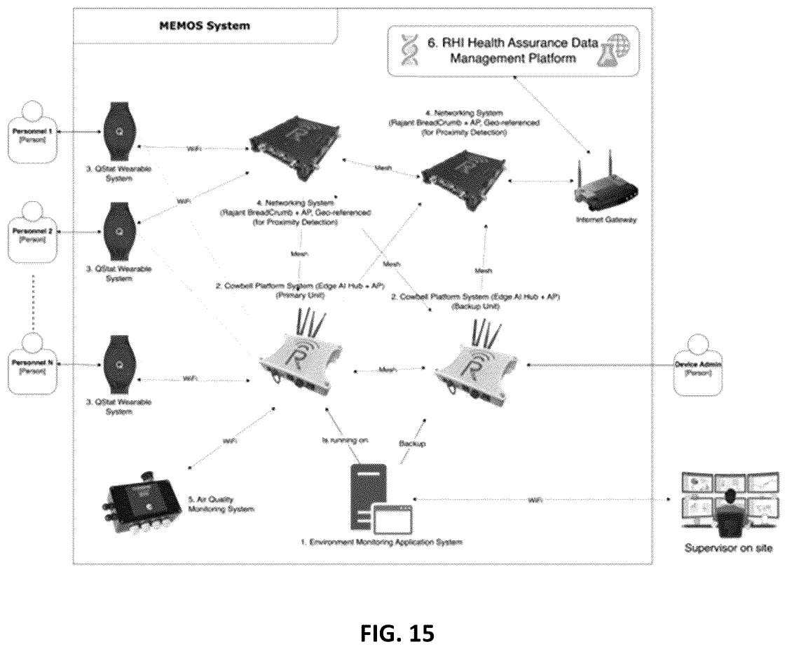

The Military Environmental Monitoring and Occupational Safety Reporting System (MEMOS) project deployment architecture illustrated by FIG. 15 aims to include functionalities for addressing hazardous threat exposure.

The MEMOS system combines several hardware and software components to remotely monitor warfighter health and environmental conditions. More details on each component of the MEMOS system are presented below:

[Component #1] Environment Monitoring Application System: This component provides a web-based interface for a supervisor to monitor their warfighters. Supervisors may log in to the application to view a map with the warfighter's proximity (i.e. physical location) and health information along with environmental information (e.g., air quality data), and receive alerts about critical incidents. The application's backend services can receive data from wearables and air quality sensors, analyze those data streams using developed algorithms, and generate alerts if warfighter vitals or air quality readings exceed predefined thresholds. The software allows them to monitor warfighter vitals in real-time and access historical data.

[Component #2] Cowbell Platform System (Edge AI Data Hub): This platform provides the software, hardware, and networking infrastructure needed to manage a cluster of such systems and other peripherals like wearables and air quality sensors, host a variety of applications to ingest and monitor data from these peripherals, process the data to facilitate real-time incident response, and act as a gateway to forward the data reliably to external systems for further analysis.

[Component #3] QStat Wearable System: These are worn by warfighters and collect physiological data such as heart rate, skin temperature, and oxygen saturation. They wirelessly transmit that data to the applications hosted in the Cowbell platforms for processing.

[Component #4] Networking System (Rajant BreadCrumb®): This component constitutes devices called Rajant BreadCrumbs® which form a highly resilient, low-latency mesh network called the Kinetic Mesh Network and wireless connectivity throughout the operational area. Each Rajant BreadCrumb® has the intelligence of Rajant's proprietary InstaMesh® networking software on board, which dynamically selects the best cost-effective path or paths for delivery from these meshed connections. Cowbells and other traditional Rajant BreadCrumbs® can form very large and very dense highly resilient distributed wireless mesh networks ensuring packet routing over multiple paths and frequencies to provide low-latency high capacity guarantees for bandwidth-intensive applications ensuring no single point of failure.

[Component #5] Air Quality Monitoring System (AQS): These sensors monitor environmental factors like carbon monoxide, carbon dioxide, and oxygen levels. They send their readings to the Cowbell Platform for analysis and integration with the warfighter's health data.

[Component #6] RHI Health Assurance Data Management Platform (Optional): This is a data storage system that can be connected to the Edge hub for long-term storage of warfighter health and environmental data. It might also offer advanced analytics capabilities.

These components are designed to work together seamlessly and provide a comprehensive picture of warfighter health and environmental conditions in remote locations.

### Additional Considerations

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A distributed computing platform, comprising:
a plurality of hardware computing devices, each comprising non-transitory computer readable storage media, one or more hardware computer processors, and one or more network communication modules; and
software modules, stored on each of the hardware computing devices, that, when executed by the hardware computer processors:
enable automatic discovery of each of the hardware computing devices by each of the other hardware computing devices;
cause the hardware computing devices to form a mesh communications network; and
cause the hardware computer processors to form a cluster computing platform for collective executing an end user software application stored on the non-transitory computer readable storage media.

2. The platform of claim 1, wherein:
each of the one or more end user software applications includes hardware and software dependencies; and
the software modules cause the hardware computer processors to form the cluster computing platform by distributing the hardware and software dependencies of each of the one or more end user software applications to each of the plurality of hardware computing devices.

3. The platform of claim 2, wherein forming the cluster computing platform comprises:
providing a messaging middleware service for sending and receiving messages between each hardware computing device of the distributed computing platform;
providing structured relational databases and/or time series databases for storing data generated and/or processed by the one or more end user software applications;
providing a file store and management server for collectively storing data on the non-transitory computer readable storage media of each of the hardware computing devices; and
providing a logging server for recording log messages, by each of the hardware computing devices, indicative of the status, operations, and/or potential errors occurring across the distributed computing platform.

4. The platform of claim 2, wherein the cluster computing platform provides functionality to distribute a machine learning model to each of the hardware computing devices and apply the machine learning model by each of the one or more hardware computer processors of each plurality of hardware computing devices.

5. The platform of claim 4, wherein the functionality to distribute and apply the machine learning model comprises:
providing a model repository for storing the machine learning model; and
forming a machine learning inference server for applying the machine learning model.

6. The platform of claim 5, wherein each of the hardware computing devices includes a hardware accelerator for optimizing machine learning inference workloads.

7. The platform of claim 1, wherein each hardware computing device:
provides an endpoint for receiving data from one or more end user peripheral devices; and
provides functionality to process the received data, by the one or more hardware computer processors, in accordance with the one or more end user software applications.

8. The platform of claim 7, wherein the one or more end user peripheral devices includes one or more sensors.

9. The platform of claim 1, wherein:
the hardware computing devices form compute resources for executing the one or more end user software applications; and
the software modules provide a graphical user interface for end users to manage and allocate the compute resources.

10. The platform of claim 9, wherein the graphical user interface provides functionality to allocate processing power, memory, and/or storage provided by the plurality of hardware computing devices for the execution of one or more tasks of the one or more end user software applications.

11. Non-transitory computer readable storage media (CRSM) storing instructions that, when executed by hardware computer processor of one of a plurality of hardware computing devices:
enable automatic discovery of each of the hardware computing devices by each of the other hardware computing devices;
cause the hardware computing devices to form a mesh communications network; and
cause the hardware computer processors to form a cluster computing platform for collective executing an end user software application stored on the non-transitory computer readable storage media.

12. The CRSM of claim 11, wherein:
each of the one or more end user software applications includes hardware and software dependencies; and
the instructions cause the hardware computer processors to form the cluster computing platform by distributing the hardware and software dependencies of each of the one or more end user software applications to each of the plurality of hardware computing devices.

13. The CRSM of claim 12, wherein forming the cluster computing platform comprises:
providing a messaging middleware service for sending and receiving messages between each hardware computing device of the distributed computing platform;
providing structured relational databases and/or time series databases for storing data generated and/or processed by the one or more end user software applications;
providing a file store and management server for collectively storing data on the non-transitory computer readable storage media of each of the hardware computing devices; and
providing a logging server for recording log messages, by each of the hardware computing devices, indicative of the status, operations, and/or potential errors occurring across the distributed computing platform.

14. The CRSM of claim 12, wherein the instructions provide functionality to distribute a machine learning model to each of the hardware computing devices and apply the machine learning model by each of the one or more hardware computer processors of each plurality of hardware computing devices.

15. The CRSM of claim 14, wherein instructions provide the functionality to distribute and apply the machine learning model by:
providing a model repository for storing the machine learning model; and
cause the hardware computer processors to collectively form a machine learning inference server for applying the machine learning model.

16. The CRSM of claim 15, wherein each of the hardware computing devices includes a hardware accelerator for optimizing machine learning inference workloads.

17. The CRSM of claim 11, wherein:
each hardware computing device provides an endpoint for receiving data from one or more end user peripheral devices; and
the instructions provide functionality to process the received data, by the one or more hardware computer processors, in accordance with the one or more end user software applications.

18. The CRSM of claim 17, wherein the one or more end user peripheral devices includes one or more sensors.

19. The CRSM of claim 11, wherein:
the plurality of hardware computing devices collectively form compute resources for executing the one or more end user software applications; and
the instructions provide a graphical user interface for end users to manage and allocate the compute resources.

20. The CRSM of claim 19, wherein the graphical user interface provides functionality to allocate processing power, memory, and/or storage provided by the plurality of hardware computing devices for the execution of one or more tasks of the one or more end user software applications.
